(19) United States
(12) Patent Application Publication
(10) Pub. No.: US 2009/0063991 A1
(43) Pub. Date: Mar. 5, 2009

(54) Virtual Discussion Forum

(76) Inventors: Samuel Pierce Baron, Santa Cruz, CA (US); Tzik George Cohen, Santa Cruz, CA (US)

Correspondence Address: Ashok Tankha, 36 Greenleigh Drive, Sewell, NJ, 08080, US

(21) Appl. No.: 12/198,904

(22) Filed: Aug. 27, 2008

Related U.S. Application Data
(60) Provisional application No. 60/966,352, filed on Aug. 27, 2007.

(51) Int. Cl. G06F 3/048

(52) U.S. Cl. 715/751

(57) ABSTRACT

Disclosed herein is a computer implemented method and system for enabling real-time synchronous group interactions among participants in a virtual discussion forum. The virtual discussion forum may be a web seminar, an online conference session, an online debate, an online learning session, etc. A virtual interaction platform comprising a synchronous media layer, an interaction layer, and a reporting, archiving, and analysis layer is provided to the participants. The virtual interaction platform enables synchronous group interactions among the participants by introducing discussion issues for the virtual discussion forum. Media content related to the discussion issues is synchronously rendered to the participants. The virtual interaction platform enables the participants to interact with each other and respond to questions, polls, etc. posted in the virtual discussion forum. The virtual interaction platform determines group behavior by analyzing participants' responses and interactions and displays participants' group behavior by visually representing individual and group traits.

### CROSS REFERENCE TO RELATED APPLICATIONS

This application claims the benefit of provisional patent application number U.S. 60/966,352 titled “Virtual Discussion Forum”, filed on Aug. 27, 2007 in the United States Patent and Trademark Office.

### BACKGROUND

This invention, in general, relates to real-time online communication. More particularly, this invention relates to real-time synchronous group interactions among participants in a virtual discussion forum.

Self-expression and personal recognition drive online social interaction, as evidenced by rise of public discussions through online discussion forums and social networks. Online discussions may be performed on web forums, message boards, discussion forums, bulletin boards, and discussion boards to involve participants in one-on-one messaging, collaborative meetings, news postings etc. However, the online discussions may be predominantly discrete, asynchronous, or flat. For example, the participants post questions or problems on discussion boards seeking answers or solutions. As user interactions on discussion boards do not occur simultaneously, the participants may not find suitable answers and solutions in real time. The posted questions may remain unnoticed, unanswered, and eventually forgotten. Discussions occurring asynchronously may not get resolved quickly and people may eventually lose interest in a topic of discussion.

Conducting web seminars using available forms of online networking may not provide a satisfactory level of real-time interaction between the participants and the seminar moderator of a web seminar. Polls are conducted through short messaging services (SMS) and electronic mail services. However, the consensus results of polls through SMS or electronic mails may not be extensive as outreach may be limited.

Hence, there is a need for a computer implemented method and system that enables real-time synchronous group interactions among multiple participants in a virtual discussion forum.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above mentioned needs for enabling real-time synchronous interactions among multiple participants engaged in a virtual discussion forum. The computer implemented method and system disclosed herein provides a virtual interaction platform for enabling real-time synchronous group interactions among the participants in the virtual discussion forum. The virtual discussion forum may be, for example, one of a web seminar, an online conference session, an online social gathering, an online debate, an online learning session, etc.

The participants engage in online discussions, debates, or learning sessions related to discussion issues in the virtual discussion forum. The participants may be discussion forum users or discussion moderators. The virtual interaction platform comprises a synchronous media layer, an interaction layer, and a reporting, archiving and analysis (RAA) layer.

The virtual interaction platform enables real-time synchronous group interactions among the participants in the virtual discussion forum. The participants may join the synchronous group interactions on the discussion issues based on real time user activity in the virtual discussion forum. Discussion issues are introduced in the virtual discussion forum to initiate the synchronous group interactions on the discussion issues. The virtual interaction platform synchronously renders media content related to the discussion issues to the participants using the synchronous media layer. The media content is obtained from multiple media sources. The synchronously rendered media content is live media content, recorded media content, and a combination of both, live and recorded content. The interaction layer of the virtual interaction platform provides each of the participants with a graphical user interface comprising componentized and configurable interaction modalities.

The participants may use the componentized and configurable modalities for the real-time synchronous group interactions in multiple modes. The participants may use one or more chat messages, bubble messages, comment components, user icons, and graphical user interface widgets during the synchronous group interactions. The participants in the due course of a discussion or a web seminar may generate responses on the discussion issues or topics other than the discussion issues using the interaction layer. The responses from the participants may comprise blurbs, opinions, feedbacks, responses to polls and quizzes, etc. In a web seminar, the feedback from the participants may be used to break autonomic nature of the web seminar. The participants may be polled with questions based on the discussion issues.

The RAA layer of the virtual interaction platform analyzes group behavior of the participants based on the generated responses. The RAA layer analyzes the generated responses from each of the participants during the synchronous group interactions. The group behavior comprises preferences and level of involvement of each of the participants during the real-time interactions. Further, the group behavior determined by the RAA layer may be used for visually representing group characteristics of the participants. The interaction layer dynamically displays the group behavior of the participants as crowd visualization. The crowd visualization is a graphical or pictorial representation of individual or group traits of the participants.

The virtual interaction platform further comprises a social networking layer, a marketing layer, an administrative layer, and an operations layer. The social networking layer facilitates asynchronous group interactions among the participants. The social networking layer manages the following tasks: participants profile creation, determining relationships among participants, establishing relationships among the participants, etc. The social networking layer may provide asynchronous community features to the participants. The asynchronous community features may comprise online scoring games, online rating games etc. The marketing layer enables targeting of in-platform advertisements, sponsorships, product placement, merchandising, etc. to the participants in the virtual discussion forum.

The administrative layer provides tools and application programming interfaces for managing virtual discussions, customizing the virtual interaction platform, branding, marketing and merchandising, authenticating the participants, and managing administrative functionalities. The administrative layer enables administrative management of media content, virtual discussion forums, captured session data, user accounts, branding, and live production on the virtual discussion forum. The administrative layer manages administrative accounts, of platform partners and administrators of the virtual interaction platform. The platform partners may comprise partner websites, sponsoring partners, etc of the virtual interaction platform.

The reporting functionality of the RAA layer enables the administrators and the platform partners to export activity data and display analyses of the participants, via the administrative layer. For each discussion session of the virtual discussion forum, the RAA layer archives media and user activity, including discussion issues, multimedia content, user activity log, user activity analysis reports, etc., for future review and analysis of the archives. The operations layer supports turnkey hosted solution provided by the platform partners on the virtual interaction platform.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method for real-time synchronous group interactions among multiple participants in a virtual discussion forum.

FIG. 2 illustrates a computer implemented system for real-time synchronous group interactions among multiple participants in a virtual discussion forum.

FIG. 3A exemplarily illustrates a lobby view of multiple discussion forums.

FIG. 3B exemplarily illustrates real-time interaction among multiple participants in an online debate on a virtual discussion forum.

FIGS. 4A-4B exemplarily illustrate a web seminar conducted on a virtual discussion forum.

FIGS. 5A-5C exemplarily illustrate crowd visualization on a virtual discussion forum.

FIG. 5D exemplarily illustrates display of responses from multiple participants in a virtual discussion forum.

FIG. 6 exemplarily illustrates graduated interactions modes on the virtual interaction platform.

FIG. 7 exemplarily illustrates interactables of graduated interactions modes on the virtual interaction platform.

FIG. 8 exemplarily illustrates structured bubble comments of graduated interactions modes on the virtual interaction platform.

FIG. 9 exemplarily illustrates dial testing component of graduated interactions modes on the virtual interaction platform.

FIG. 10 exemplarily illustrates polling interface of the polling engine on the virtual interaction platform.

FIGS. 11-20 exemplarily illustrate administrative functionalities provided to a platform partner of the virtual interaction platform.

FIG. 21 exemplarily illustrates a trivia interface of the polling engine on the virtual interaction platform.

FIG. 22 exemplarily illustrates asynchronous community game on the virtual interaction platform.

### DETAILED DESCRIPTION OF THE INVENTION

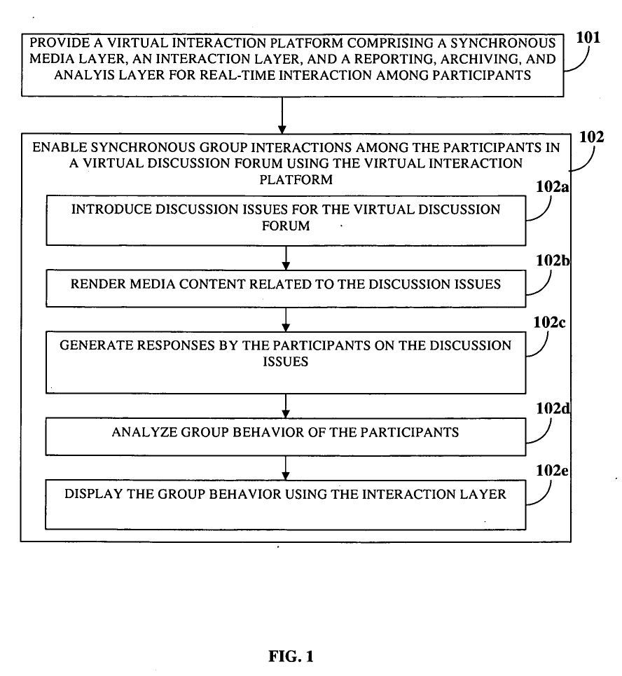

FIG. 1 illustrates a computer implemented method for real-time synchronous group interactions among multiple participants in a virtual discussion forum. The participants may comprise discussion forum users or discussion moderators. The computer implemented method disclosed herein provides 101 a virtual interaction platform to the participants for the synchronous group transactions. The virtual interaction platform comprises a synchronous media layer, an interaction layer, and a reporting, archiving and analysis (RAA) layer. The virtual discussion forum is created on a virtual interaction platform. The virtual discussion forum may be one of a web seminar, an online conference session, an online social gathering, an online debate, an online learning session, etc.

The virtual interaction platform enables 102 synchronous group interactions among the participants in the virtual discussion forum. One or more participants or the platform partners or both, may introduce 102a discussion issues to initiate the synchronous group interactions among the participants on the introduced discussion issues in the virtual discussion forum. For example, in a web seminar, the discussion issues may be introduced by a seminar moderator. The seminar moderator may prequalify the discussion issues prior to introducing the discussion issues. In public discussion forums, the discussion issues may be introduced by one or more discussion forum users. The virtual interaction platform may also introduce the discussion issues automatically to initiate the synchronous group interactions. The participants may also join active synchronous group interactions on the discussion issues based on real time user activity in the virtual discussion forum.

The discussion issues present an agenda for virtual group discussions among the participants. When a virtual group discussion is an online discussion forum, the agenda may comprise debate topics, current affairs, latest news, public polls, etc. An individual discussion may also have more than one topic, and the topic may evolve during the course of the discussion, as determined by the platform partner, host, discussion forum users, etc. In case of a web seminar, the discussion issues may be centered around a predetermined curriculum or topics of learning. The media content related to the discussion issues are submitted to the virtual interaction platform. The virtual interaction platform obtains the media content related to the discussion issues from multiple media sources. The multiple media sources comprise the participants, the administrators of the virtual interaction platform, the platform partners, a host of the virtual discussion forum, news agencies, third party advertisers, marketing agencies, etc.

The virtual interaction platform then synchronously renders 102b the multimedia content obtained from the multiple media sources to the participants using the synchronous media layer. The synchronous media layer enables synchronous group viewing of media content obtained from multiple media sources. The media content comprises recorded media content, live media content, or any combination thereof. For example, the multimedia content may be a live or a recorded television program being broadcast concurrently on television and online within the virtual discussion forum. Multiple instances of media content may be displayed simultaneously. Further, the media content may be provided by administrators of the virtual interaction platform, a platform partner of the virtual interaction platform, or the discussion forum users of the virtual interaction platform. Platform partners of the virtual interaction platform may comprise partner websites, sponsoring partners, advertisers, marketing agencies, etc. During the virtual group discussion, one or more participants may submit questions and polls related to the discussion issues.

The participants generate responses 102c on the discussion issues using the interaction layer. The interaction layer comprises componentized and configurable modalities for generating responses from the participants in multiple modes during the synchronous group interactions. The participants use chat messages, bubble messages, comment components, participant icons, and graphical user interface widgets of the interaction layer to generate the responses during the synchronous group interactions.

The response from the participants may be a response to one of a query, a poll, a questionnaire, etc. The participants may also respond to the synchronously rendered media content. The participants may direct or affect course of the virtual group discussions by suggesting discussion topics, moderating the virtual group discussions, etc. Further, the responses from the participants during the virtual group discussion may affect discussion activity, including the live and recorded media content. For example, a live debate may be broadcast on television and online from television media feeds. The participants' activity during the live debate such as polls, participants' comments, views, opinions, etc., may be fed back into the television broadcast to augment broadcast content. The polling activities during the live debate and the comments from one or more participants based on the television broadcast may be available for general viewing by the participants involved in the live debate.

The RAA layer analyzes 102d the group behavior of the participants based on the generated responses from the participants. The analysis of the generated response additionally assists in deriving crowd visualization. The reporting functionality of the RAA layer enables the platform partners and the administrators to export virtual group discussions data and display analysis of the participants' activity within the virtual group discussions, via the administrative layer. The participants' activity may be viewed in real time during a discussion session or as an archive during or after the discussion session. The RAA layer archives each virtual group discussion including media content, participants' activity logs, analysis of the virtual group discussions, etc. for future use.

The group behavior is displayed 102e in a suitable form by the interaction layer. The interaction layer comprises a graphical user interface (GUI) for displaying the group behavior. The interaction layer dynamically displays the group behavior of the participants as one or more crowd visualizations. The crowd visualization is a graphical or pictorial representation of individual or group traits of the participants. The crowd visualization exhibits emergent group patterns such as polarity, popularity, and attraction. The interaction layer utilizes analysis results from the RAA layer to display the group behavior of the participants in real time during a virtual discussion session.

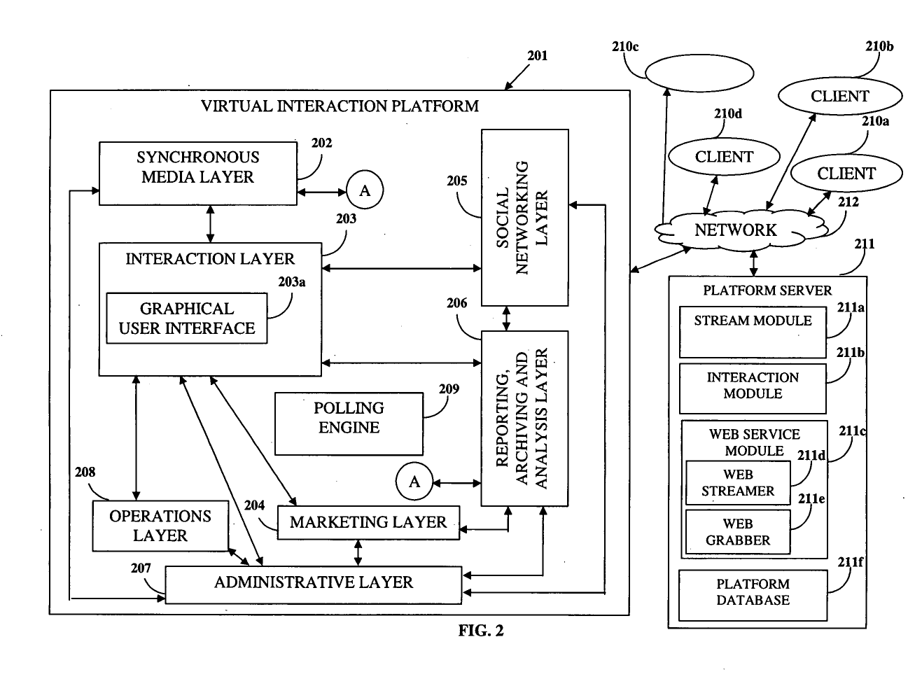

FIG. 2 illustrates a computer implemented system for real-time synchronous group interactions among multiple participants in a virtual discussion forum. The system disclosed herein comprises a virtual interaction platform 201. The virtual interaction platform 201 enables participants to interact in real time collectively as a group on a discussion issue or curriculum. The virtual interaction platform 201 utilizes an inner login for supporting user login and providing application wrappers.

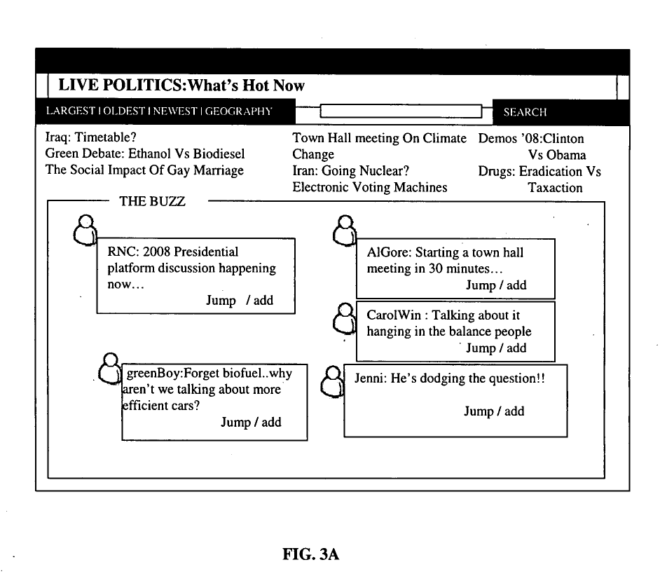

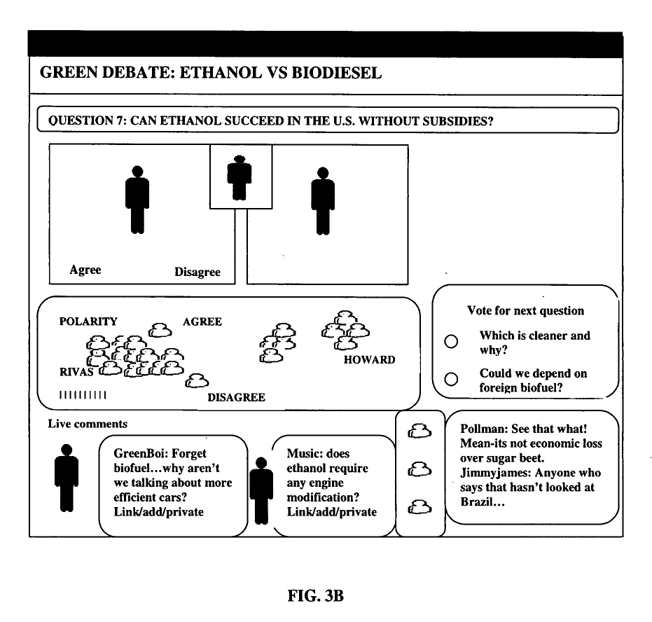

The virtual interaction platform 201 comprises a synchronous media layer 202, an interaction layer 203, a reporting, archiving, and analysis (RAA) layer 206, a marketing layer 204, an administrative layer 207, a social networking layer 205, and an operations layer 208. The synchronous media layer 202 provides synchronous group viewing of multiple live or recorded media content obtained from multiple media sources. The virtual interaction platform 201 renders media content related to related discussion issues obtained from multiple media sources to the participants using the synchronous media layer 202. The media content comprises recorded content and live content. The synchronous media layer 202 facilitates co-viewing of the synchronously rendered video content. The synchronously rendered video content may comprise one or more video streams of live or recorded content, for example, music videos, television episodes, feature films, and live streams from online and television broadcast or participant webcams. A video application featuring multiple video windows streaming both recorded content and live content from real world events in different cities is illustrated in FIG. 3B.

The virtual interaction platform 201 utilizes a platform server 211 for enabling the real-time synchronous group interactions. The platform server 211 hosts discussion sessions and maintain connections to the client applications to display participant activity in real time. The platform server 211 may also render media content directly to client devices 210a, 210b, 210c, and 210d of the participants independent of the stream module 211a via a content distribution network (CDN) for synchronized distribution of the media content to the client devices 210a, 210b, 210c, and 210d. The virtual interaction platform 201, the platform server 211, and the client devices 210a, 210b, 210c, and 210d are connected via the network 212.

The platform server 211 comprises a stream module 211a, a web service module 211c, an interaction module 211b, and a platform database 211f. The synchronous media layer 202 utilizes the stream module 211a for rendering the media content related to the discussion issues to the participants. The stream module 211a publishes the media content to the participants. The web service module 211c may comprise a web streamer 211d for streaming non interactive media content on demand of the participants. The web streamer 211d may publish synchronized video streams directly to the participants or indirectly via the stream module 211a. The web streamer 211d may be facilitate streaming of video content in multiple formats, webcam content, live content and on-demand recorded content for interactive discussion sessions. The web streamer 211d may also facilitate stream scheduling and management. The web service module 211c may also comprise web grabber 211e for capturing user-selected scenes grabbed from real-time streaming video content.

The interaction module 211b controls changeovers during entry and exit of the participants from a discussion session on the virtual interaction platform 201. The interaction module 211b maintains count of the participants during a discussion session. The interaction module 211b also manages session setup based on discussion session schedule and configuration information in the platform database 211f. The platform database 211f stores and retrieves user account information, session schedule and session information, trivia questions, partner and client configurations, and logging of diagnostics and session activity via the interaction module 211b. The interaction module 211b may also manage the session setup based on application business rules relevant to software applications utilized for a particular discussion session. The interaction module 211b is responsible for load-balancing sessions hosted by the platform server 211. The interaction module 211b synchronizes and maintains media content via a shared content list resident on the platform server 211.

The synchronous group interactions depend upon active participation from the participants involved to keep the interactive experience appealing to the participants. The virtual interaction platform 201 facilitates personal expression and interaction to each of the participants through the interaction layer 203. The interaction layer 203 enables the participants to generate interactions and responses on the discussion issues using the interaction module 211b. The interaction layer 203 provides configurable and componentized modalities for real-time group interaction. The modalities comprise graduated interaction modes, activity based initiation, and crowd visualization. The interaction module 211b manages implementation of the modalities, for example, crowd visualization, dial testing, activity based initiation, etc.

The graduated interaction modes are provided to facilitate the participants to interact with each other synchronously in a virtual discussion forum at different comfort levels of interaction preferred by the participants. The graduated interaction modes provide a specific level of safety and intimacy to each of the participants based on the comfort level of the participants. Further, the graduated interaction modes enable a participant to escalate interaction with other participants when preferred by the participant. A participant may choose “passive interaction” with other participants in order to learn about the other participants through available participant information and participant profiles. The comfort levels of interaction may facilitate real time group chat, exchange of private messages, public forum chat etc. The graduated interaction modes implemented within a graphical user interface (GUI) 203a of the interaction layer 203 comprise chat messages, bubble comments, comment components, user icons, gestures, interactables, graphical user interface widgets and similar graphical objects, and animations for providing an engaging, social, interactive and participatory environment in the virtual discussion forums. The graduated interaction modes are illustrated in FIG. 6. The interaction module 211b manages lobby and session activities of the participants on the virtual interaction platform 201 provisioned by the graduated interaction modes through comments, gestures, private chat, and trivia exchanged between the participants.

The graduated interaction modes may comprise a user presence component to display the participants involved in a discussion session. The user presence component provides interactive options to the participants for exploring a virtual discussion form and interacting with participants involved in the virtual discussion forum. Exemplarily, each participant may be represented by a graphic user avatar. The graphic user avatar may be static, animated, or a live video feed from the participants' webcam. The flexibility of the graphic user avatar offers different ways of expressing individual identities to the participants.

The graphic user avatar also enables the user presence component to support diverse range of applications. The user presence component offers multiple layout options for groups of graphic user avatars. For example, the graphic user avatars may stack into rows, and shrink in size as group size of the participants involved grows. Each graphic user avatar may support a pop-up rollover menu comprising participant name, participant information comprising age, gender, and location, interactive avatar, link to a participant profile, personal ringtone. The graphic user avatar may also comprise moderation controls, for example, “block”, “eject”, and “make moderator”, social networking controls, for example, “add friend” and “gift”, and communication controls, for example, “chat” and “message”.

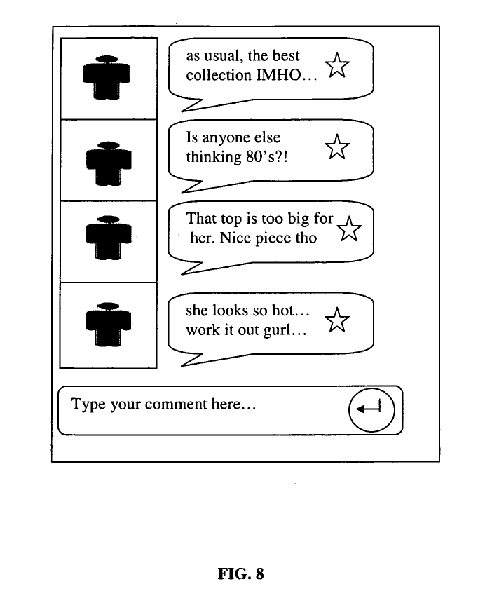

The bubble comments serve as a mainstay of personal expression. The bubble comments may appear as text in speech bubbles emanating from participants' graphic user avatars on the GUI 203a of the interaction layer 203, and then fade after a predefined period of time. In a distributed model, the speech bubbles are placed randomly on the virtual interaction platform 201. Unlike a standard text chat box structured for direct user-to-user interaction, the bubble comments are undirected and temporary in nature. The bubble comments enable instant responses from the participants. The participant may voice opinions regarding the synchronously rendered media instantly and not obligated to converse with other participants. The bubble comments may also appear in a structured presentation with the bubble comments stacking up vertically and fading after a predefined time as illustrated in FIG. 8. The bubble comments may also be configured to include a link for flagging a comment made by other participants as a favorite. An associated number with a bubble comment may display number of times the comment has been flagged as a favorite. Marking favorites is one example of a platform feature that enables the participants to gain points, status, and recognition based on participants' participation in real-time discussion sessions.

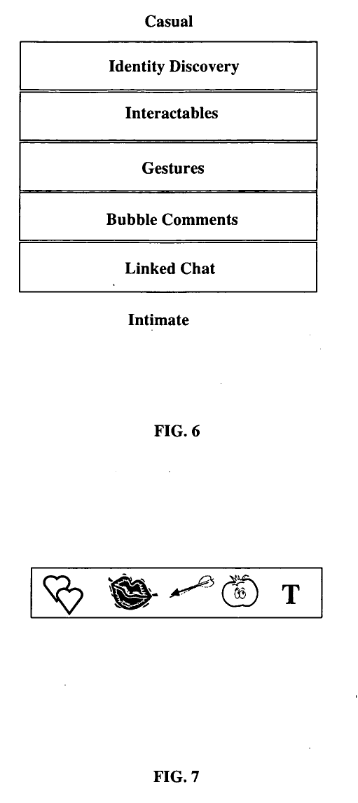

The interactables of the graduated interaction modes may be represented by multiple graphical objects comprising thought, speech, and cartoon bubbles, projectiles, etc. The interactables are illustrated in FIG. 7. The interactables may comprise animated objects usable by the participants to target or “throw” the animated objects on a visual area of the GUI 203a of the interaction layer 203. The interactables enable direct interaction between the participant and discussion session content. The interactables provide an interactive mode of personal expression and a degree of anonymity to the participants in order to enable very low-risk participation from the participants. The interactables may include projectiles, for example, tomatoes, arrow, darts, beating hearts, kisses, etc. The interactables may also include comic book words and sounds in visual and auditory punctuation. When an interactable is activated, the participants involved in the discussion session experience the interactable animation and sound in real-time. The interactables may also be customized for content or branding.

The gestures are graphic user avatar actions for expressing a participant's emotion at a particular instant depending on the discussion session content or other participants' comments. For example, the gestures might express laughter, disapproval, celebration etc. The gestures may cause a graphic user avatar to move or change appearance, accompanied by a sound. Gesture control may be subtle and complex, with action and sound volume based on participants' triggering action of the gesture and contextual factors, for example, the number of users in the virtual discussion session. For example, an “LOL” gesture may cause the graphical user avatar bounce and play a laughter sound. The gesture may be “touch sensitive” to facilitate the graphic user avatar to bounce higher and laugh louder on repeated clicking of the graphic user avatar. The gestures may be interactive, for example, the participants may “high five” other participants.

The objective of the activity based initiation is to guide the participants having common interests into a related discussion forum, based on the participants' activity in real-time on the virtual interaction platform 201. A participant may select a particular virtual discussion forum from multiple discussion forums. The activity based initiation for assisting the participant in choosing a particular virtual discussion forum is exemplarily illustrated in FIG. 3A. The activity based initiation consolidates and presents comments and participant activity from active virtual discussion forums in real time. A visiting participant may then select a virtual discussion forum of interest from the presented participant activity at a given instance of time. Comments from existing participants may appear as bubbles on the GUI 203a of the interaction layer 203, and then fade after a predefined period of time. By clicking on a comment made by an existing participant of a virtual discussion forum, the visiting participant enters the selected virtual discussion forum. The temporary nature of the bubbles gives a sense of immediacy and presents instantaneous participant activity in order to initiate real-time participation from the visiting participants. The bubbles create an implicit “call-to-action” effect, thereby enabling the visiting participant to join a discussion session of interest to the visiting participant. As the bubbles appear, corresponding discussion session name is highlighted in the structure list of bubbles.

The system disclosed further comprises a polling engine 209. The polling engine 209 conducts polls the participants with questions based on the discussion issues. The polling engine 209 enables the participants, the platform partners, and the administrators of the virtual interaction platform 201 to author questions to be presented to the participants during the virtual group discussions. The polling engine 209 may be used to conduct online polls and quizzes, and collect statistical data and information about the participants. The polling engine 209 has a provision to time submission of poll questions in relevance to the streaming media content during the virtual group discussions. Polling logic is set based on the responses from the participants by providing contextual questions to the participants as a poll. Flexibility of the polling logic aids in delivery of poll questions consistent with a participant's interests and following branching lines of inquiry established by a poll author. The poll questions can be generally or specifically associated with sponsorship or advertising from third party agencies. Specific parameters of a participant's activities such as participant's comments frequency, participant's comment ratings, and response frequency are captured to map participant's interest level to the participant's activities during a discussion.

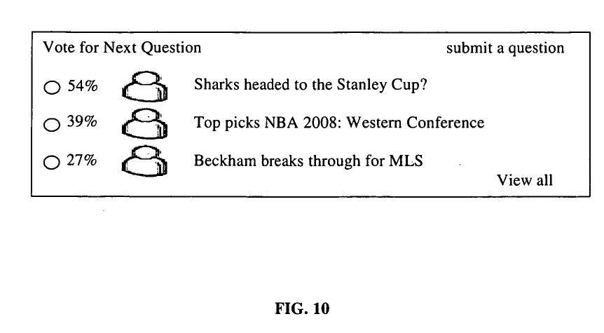

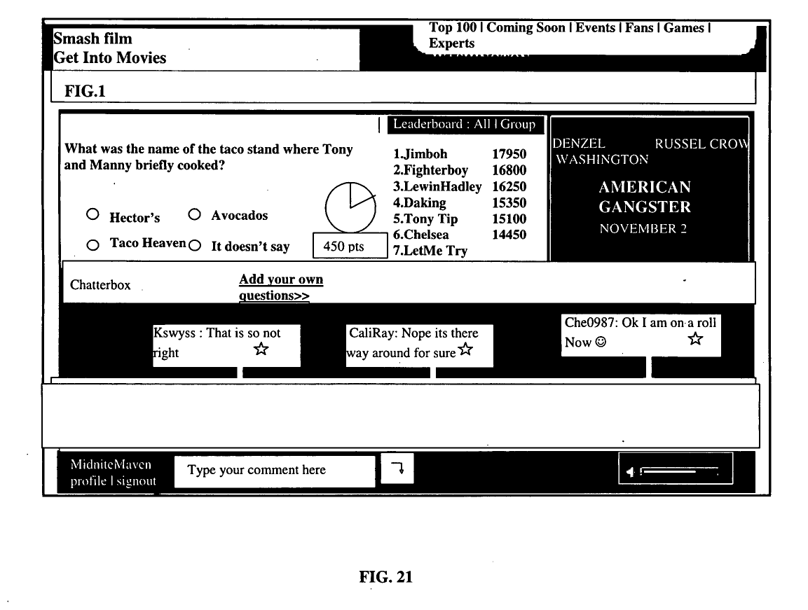

The polling engine 209 enables the administrators to create engaging trivia games and informative polls. The administrators may utilize an administrative console for provisioning quizzes or polls and obtaining secure results tracking of the responses from the participants to the polls. Question formats for the polls are flexible and individual questions may be timed to the discussion session or to particular rendered media content. The questions may also be branded. The polls may have branching polling logic based on the responses from the participants. The polling interface of the polling engine 209 is illustrated in FIG. 10. The participants may also submit trivia or poll questions, enabling additional engagement with the media content during a discussion session. The trivia interface is illustrated in FIG. 21.

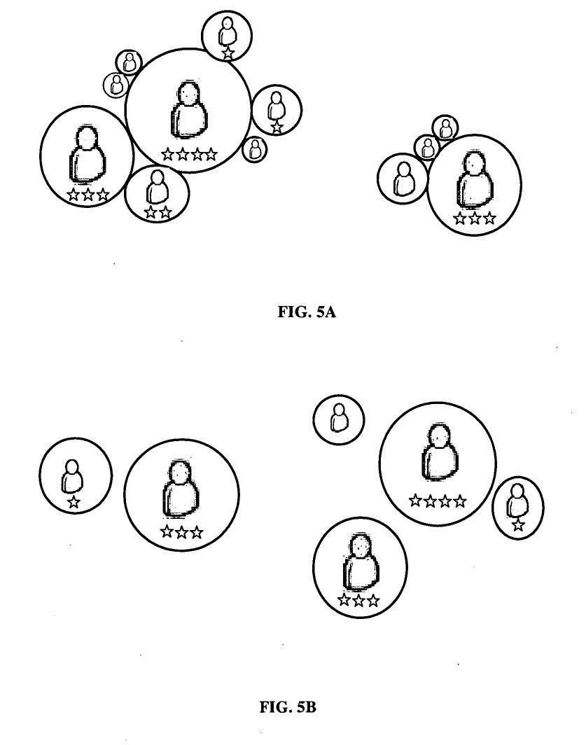

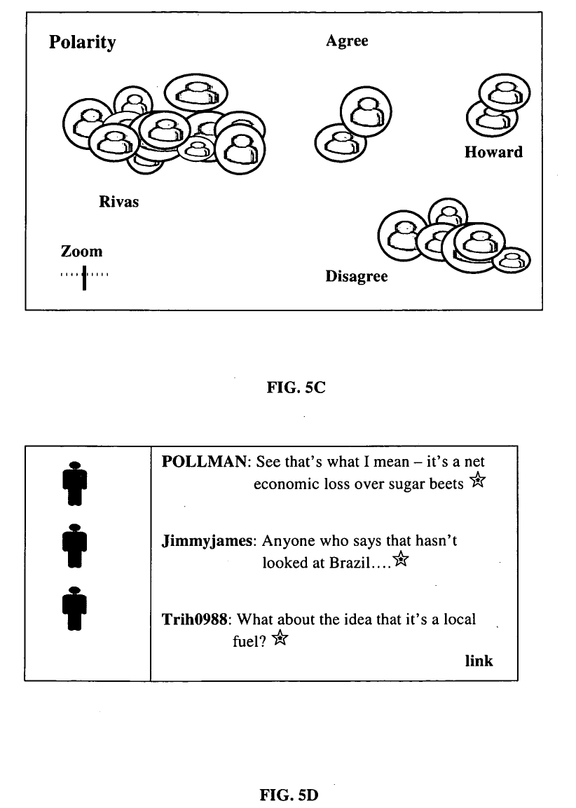

The crowd visualization enables categorization of the participants based on the individual traits of each of the participants. The crowd visualization provides real-time feedback related to the online session activity of the participants to the moderators of discussion sessions and the participants, including responses of the participants related to the discussion issues and interactions among participants. By providing the feedback on the online session activity visually, participants may assess and understand the group behavior and group dynamics of the real-time discussion session, increasing a sense of involvement in a real group experience. Each of the participants is categorized based on traits such as attraction, popularity, and polarity. Attraction denotes liking of a participant or a participant's perspective by rest of the participants. A cluster of circular images with each image pictorially depicting a participant is used to represent the attraction between one participant and the other participants. Attraction groups avatars together spatially, to show clustering of users. Unlike polarity and popularity, attraction is based on frequency of activity (such as linked chat or private messages) and social context (such as teams) rather than content. FIG. 5A illustrates the crowd visualization through attraction.

Relative popularity of the participants in a group may be illustrated on the interaction layer 203 using size, color, and associated designations. The popularity may address physical attraction, ranking of comments etc. within a real-time environment. FIG. 5B illustrates the crowd visualization through popularity. Polarity indicates level of agreement between a participant's viewpoints with another participant's viewpoints. Also, polarity shows alignment with a participant, a discussion moderator, a debater, a discussion forum user, a concept, an attribute. The polarity indicates if a group comprising the participants is polarizing or uniting with respect to a particular viewpoint during the virtual group discussion. FIG. 5C illustrates the crowd visualization through polarity. During a real-time discussion session, the participants may be presented with ratings choices. The responses from the participants to the rating choices may position the graphic user avatars of the participants within an alignment interface on the interaction layer 203. The alignment of the participants may be represented simultaneously, as a two dimensional or a three dimensional image. The image may be zoomed in and out for large groups of participants to visually assess and track moods, values, likes, and orientations against the rendered media content for large groups of participants during course of a real-time discussion session.

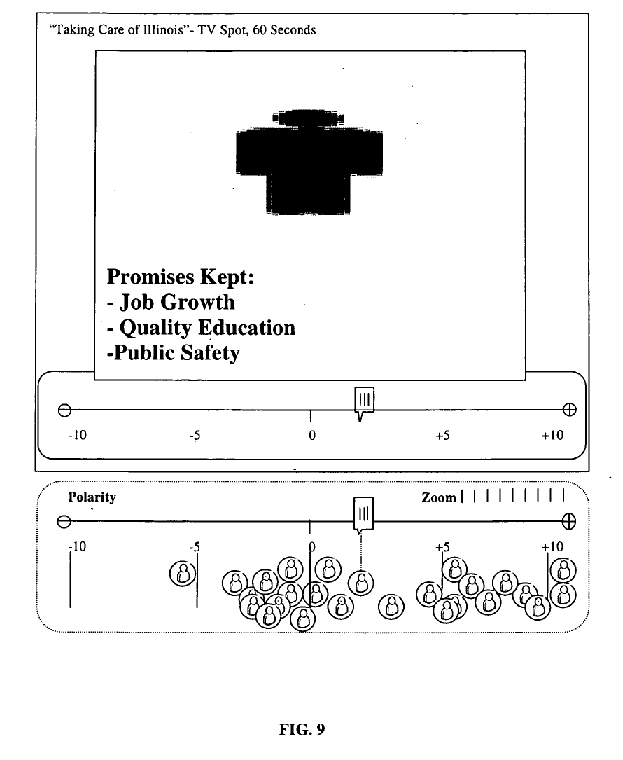

The graduated interaction modes may further comprise a dial testing component to gather participant response data to the rendered media content. The dial testing component may gather feedback from multiple participants in a short period of time and at low cost. The dial testing component may feature a slider. The slider may reset to a center alignment in a short period of time if the slider is released. The dial testing component is illustrated in FIG. 9.

The synchronous media layer 202 and the interaction layer 203 may be closely coupled to allow the interaction layer 203 to control the synchronous media layer 202 to extending range of interactive features provided to the participants. For example, clickable “hotspots” may be placed at specific points in the media. The “hotspots” may be time coded over specific areas of media presentation. By clicking a hotspot, a participant may control media playback in order to jump to a different scene in the displayed media content, select a different piece of media content, or engage in group games or activities.

The RAA layer 206 analyses group behavior of the participants using the generated responses from the participants. The RAA layer 206 provides unique, real-time insight into participant taste, mood, alignment, interest level, and learning level in a virtual group discussion. The group behavior or the group dynamics such as polarity, popularity, attraction, etc., may be determined by the RAA layer 206 and visually presented using the interaction layer 203. The GUI 203a of the interaction layer 203 graphically displays the group behavior analyzed by the RAA layer 206. The reporting functionality of the RAA layer 206 enables the platform partners and the administrators of the virtual interaction platform 201 to export discussion session data and display analysis of the participants' activity in the virtual discussion forums, via the administrative layer 207. Such activity may be viewed in real time during the discussion session or as an archive during or after the discussion session. The archiving functionality of the RAA layer 206 archives the virtual group discussions including media content, participants' activity logs, analysis of the discussions, etc., for future use.

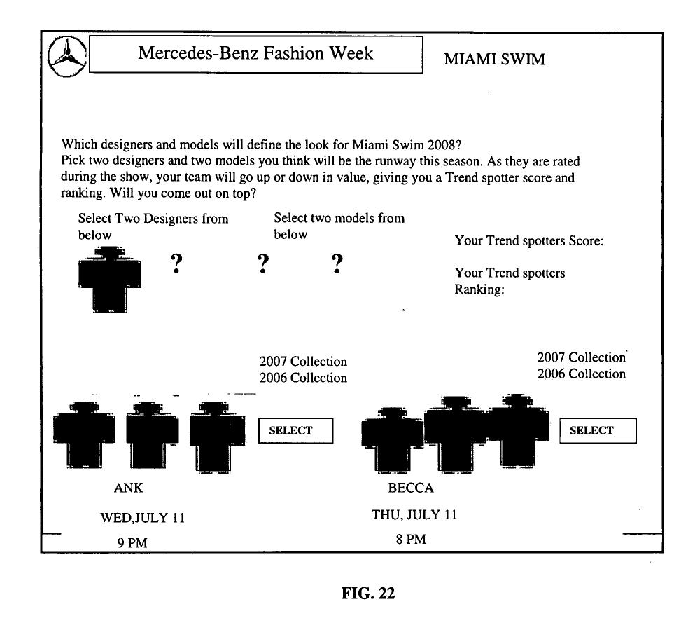

The social networking layer 205 facilitates asynchronous group interactions among the participants. The social networking layer 205 may provide asynchronous community features to the participants. The asynchronous community features may comprise online scoring games, online rating games, participant profile information, participant relationships, etc. An asynchronous community game of scoring points by selecting designers and models is illustrated in FIG. 22. The social networking layer 205 creates social networks of participants using the analyzed group behavior. The participant profiles may be automatically augmented by participant activities captured during real-time discussion sessions.

The social networking layer 205 provides social networking features. For example, the participants may add each other as friends. To add a friend, a participant clicks the “Add” link in a rollover menu presented on the GUI 203a of the virtual interaction platform 201 or in the participant profile. On clicking the “Add” link, an “Add Request” dialog is displayed to the participant. The participant can include a personal message to the “add request” if needed. If an “add request” is received by one of the participants during a discussion session, the add request pops up or appears on the GUI 203a. By accepting the “add request”, participants involved in exchange and receipt of the “add request” are mutually added to respective friends list. The friends list of each of the participants is managed in the participant's profile and comprises a list of friends of the participant.

The participant may enable only the participant's friends to view the comments made by the participant during a discussion session. Also, the participant may optionally choose to view only comments posted by participant's friends during a discussion session. The participant may view status and history of in-platform activities of the participant's friends. The participant may receive announcements when the participant's friends start or enter the discussion sessions. Further, the participant may broadcast announcements when the participant's friends start or enter the discussion sessions. Also, the participant can block other participants selectively from a discussion session, i.e. activities from the blocked participants are hidden, including comments, chat messages, etc. The blocked participants may be unblocked using an “unblock” link on the rollover menu.

The marketing layer 204 enables targeting advertisements, product placements, sponsorships, and merchandising to the participants in the virtual discussion forum. The marketing layer 204 of the virtual interaction platform 201 provides tools and application programmer interfaces (APIs) for in-platform advertising, product placement, and merchandising. Advertising agencies, third party advertisers, sponsoring partners, etc., may use the marketing layer 204 via the administrative layer 207 to target advertisements to the participants of the virtual group discussions. Advertisements may comprise text, image and animated advertisements and may be drawn from an external advertisement pool that is accessed via APIs. The marketing layer 204 further enables product placements and intelligent online merchandising on the virtual interaction platform 201, managed via the administrative layer 207.

The administrative layer 207 of the virtual interaction platform 201 interacts with rest of the layers of the virtual interaction platform 201 to enable management of the virtual interaction platform 201 by the platform partners and the administrators. The administrative layer 207 provides administrative rights to the platform partners and the administrators to manage and produce virtual group discussions, conduct polls, target advertisements, collect participant information, manage participant accounts, etc. The administrative layer 207 provides tools and application programming interfaces (API) for managing setup and production of virtual discussions, customization of the virtual interaction platform 201, branding, marketing and merchandising, authentication of the participants, and managing layers of the virtual interaction platform 201.

The web service module 211c supports single-sign on, enabling the participants to login to interactive discussion sessions with existing credentials using the administrative layer 207. The administrative layer 207 may also provide account creation to participants and store account information of the participants in the platform database 211f. The web service module 211c may also enable the participants to participate in an online session activity without signing up or logging in for selected features of the virtual interaction platform 201. The web service module 211c may authenticate the participants signing in, support guest users, and automatically assign graphic user avatars, and provide usernames to unregistered participants through the administrative layer 207.

The administrative layer 207 may comprise a user permissions component for enabling the participants to manage permissions during hosting and moderation activities in a discussion session. The user permissions component may also manage playback control, play list control, and assignment of microphones and video windows. The user permissions component may provide control options for managing the hosting and moderation activities. For example, a host of a discussion session may be provided with an “eject” option on the graphic user avatar rollover menu to remove participants from the discussion session. Roles and rules for the user permissions component may be configured via an administration console of the administrative layer 207. The administration console may enable the administrators to manage layers of the virtual interaction platform 201, the media content, and archived information. The administrators may also use the administration console to monitor real-time user activity of the participants during discussion sessions.

The administration console may be customized as per requirements of a discussion session. For example, an administration console for tournament-style head-to-head competition may have administrative functionality for provisioning tournaments and setting competition rules. The administration console schedules, manages, and monitors discussion sessions and session data and corresponding session configurations are stored in the platform database 211f. The administration console enables real-time session management, for example, blocking or removing a participant. The session management instructions are delivered to the platform server 211 via the interaction module 211b. The platform server 211 also collects online session activity data and stores the online session activity data on the platform database 211f via the interaction module 211b.

Platform partners may comprise various entities such as partner websites, partner SSO solutions, and sponsoring partners. Each platform partner may provide a solution individually via a private-labeled administration console, with a secure login. The operations layer 208 supports turnkey hosted solution provided by the platform partners on the virtual interaction platform 201 using the administrative layer 207. Administrative functionality is isolated for each platform partner. The administrative layer 207 is able to create and remove the platform partners, as well as access and manage platform partner activities, configurations, and data. The administrative layer 207 maintains administrative accounts for the platform partners, and each platform partner creates and manages respective administrative accounts. The administrative layer 207 empowers self reliant platform partners with an ability to manage the private media content and end users of the platform platforms independently. The platform partners may utilize internal teams that are a part of their business or advertising clients for managing the private media content and advertising. For example, a platform partner may assign a business team to manage the media content exclusively, without access to rest administrative functionalities on the virtual interaction platform 201. The administrative functionalities may also be customized for an advertising partner willing to manage advertising partner's private media content.

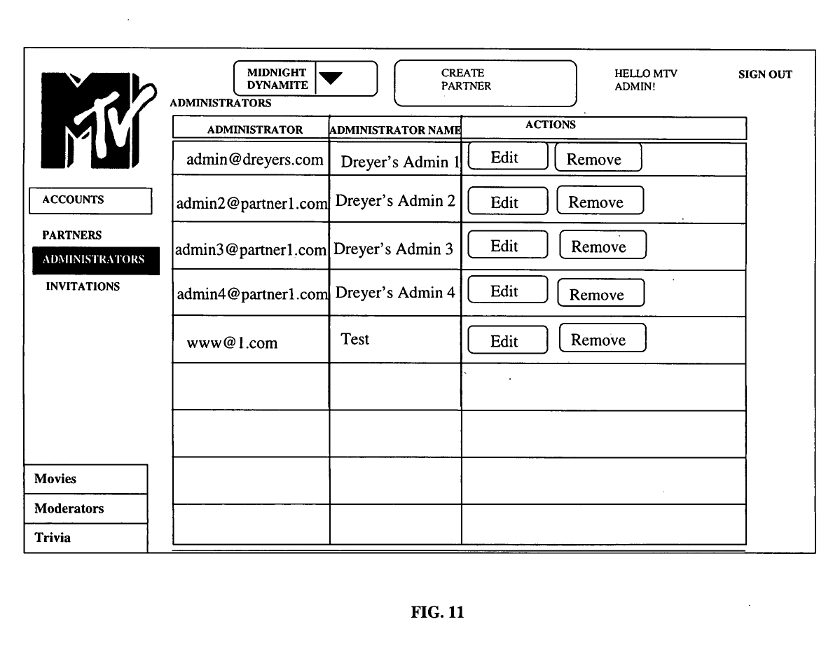

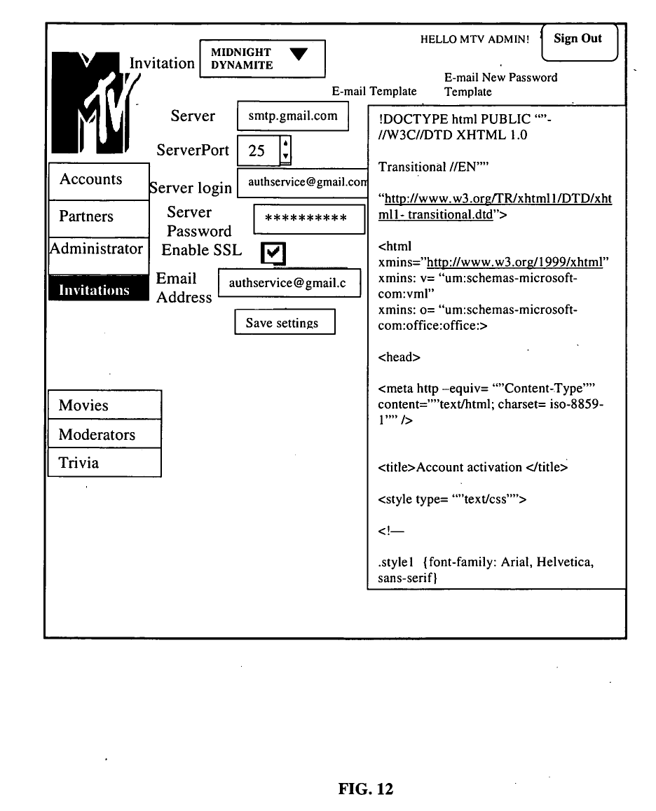

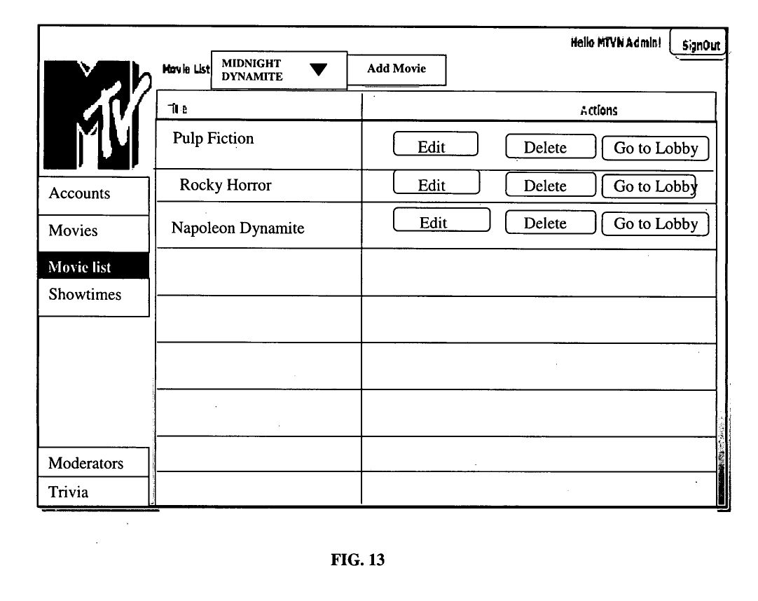

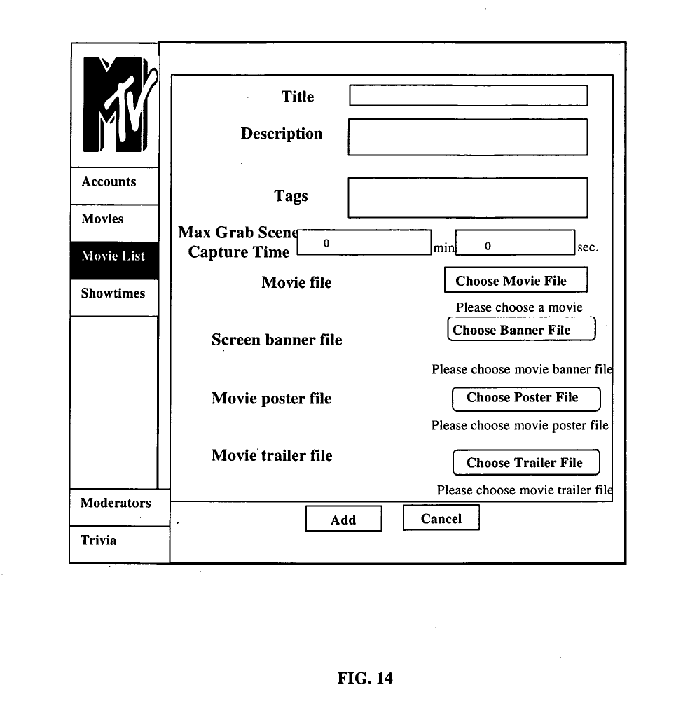

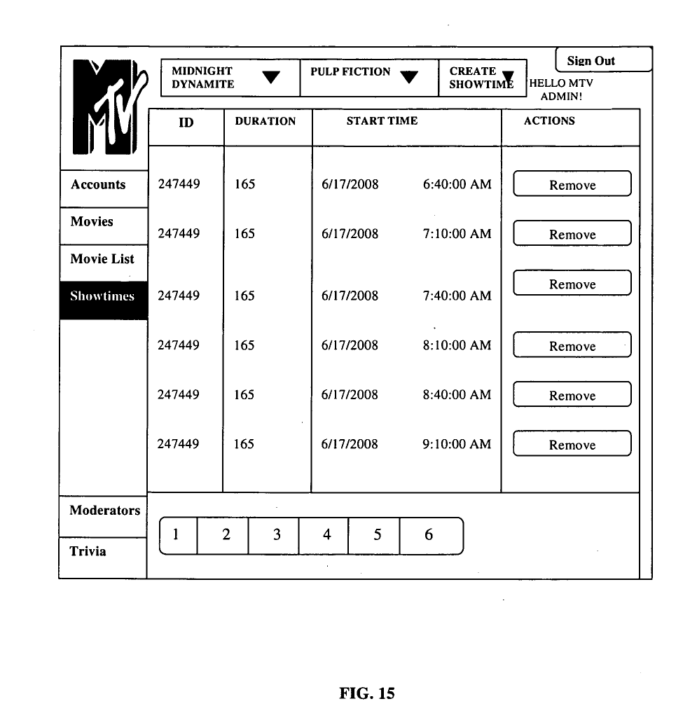

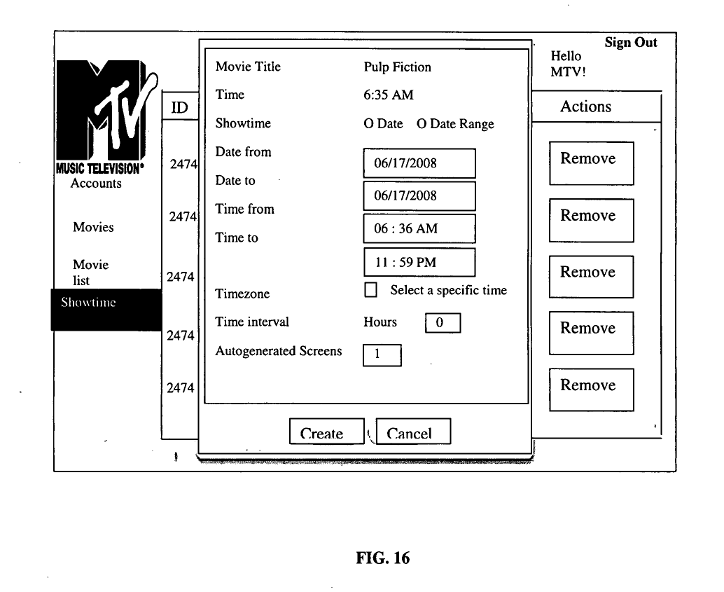

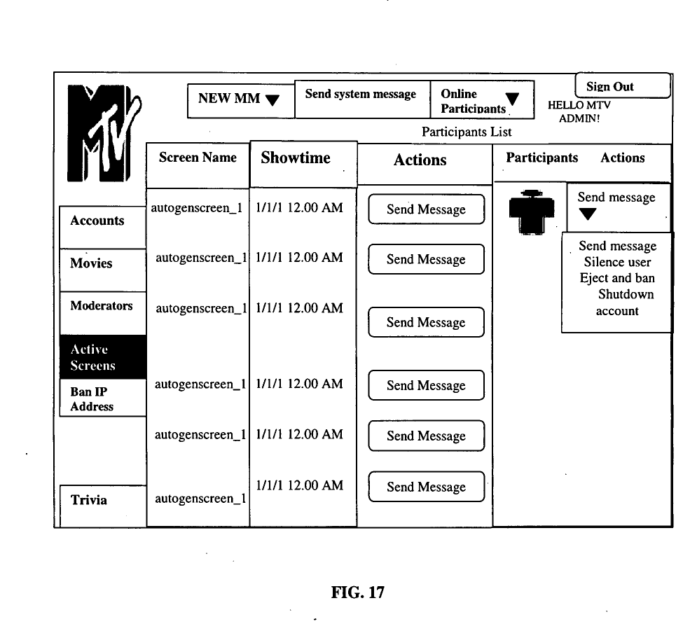

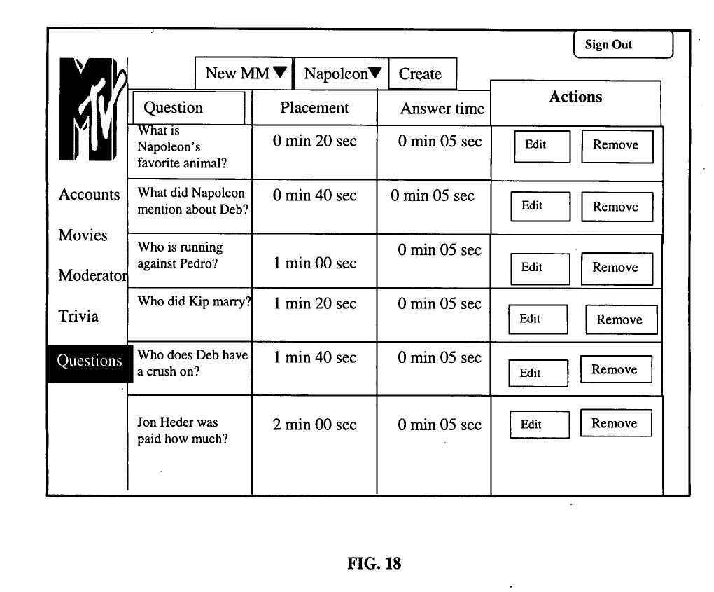

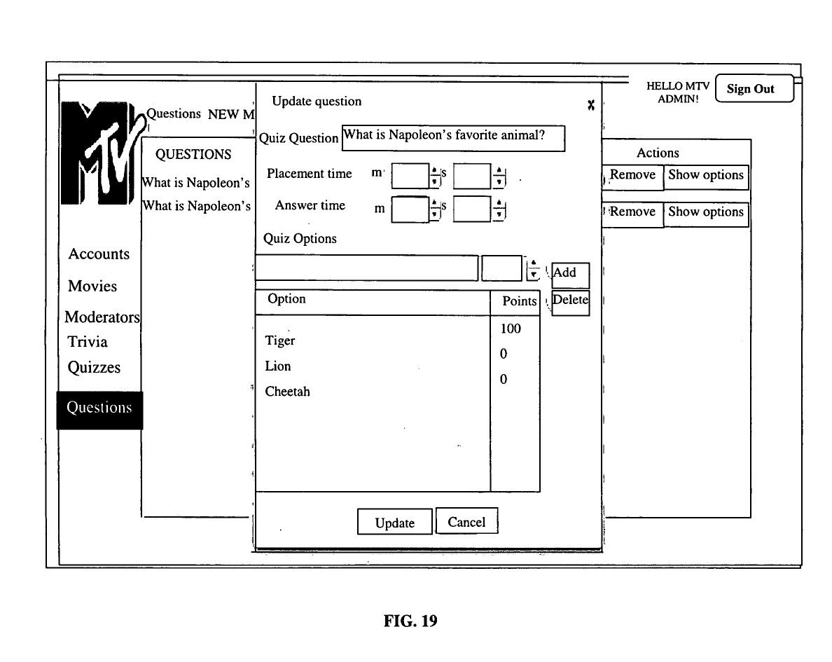

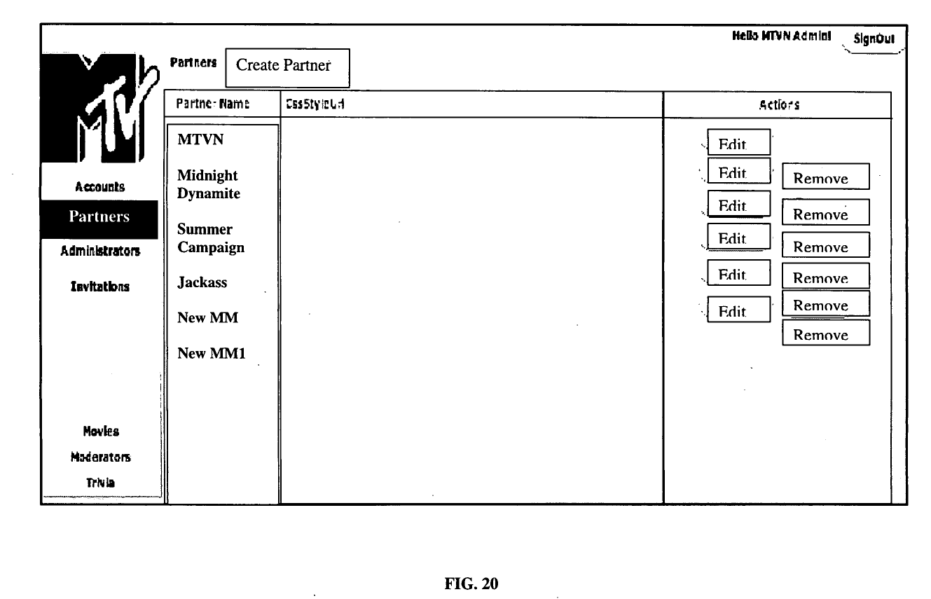

FIGS. 11-20 exemplarily illustrate administrative functionalities provided to a platform partner of the virtual interaction platform 201. An administrative console illustrated in FIGS. 11-20 is provided on the administrative layer 207 for a platform partner. In the “Accounts” tab, the administrators section enables setup and management of administrators who can configure the media content, schedule screenings, moderate users, and create trivia. The “Invitations” tab enables formatting of the screening invitation and forgot password email, with configuration information for sending messages from a platform partner email server. In the “Movies: tab, the “Movie List” shows configured content. The platform partner may use the “Movies” tab to add or edit the media content. The “Add Movie” dialog box enables assignment of movie assets and configuration of settings, for example, recording time for a scene grab feature. The “Showtimes” tab manages screening times for a movie. showtime configuration in order to set up a single screening or create screenings at about every five minutes for a month. In the “Moderators” tab, “Active Screens” provides real-time access to the participant activity during the screenings of the media content, with centralized moderation of the participants including the ability to make announcements, warn, silence, and eject abusive participants during screenings of the media content.

The “Trivia” tab provides functionality for creating and managing timed trivia quizzes and questions. Quizzes may be assigned to a movie, and questions can be assigned to specific times in the rendered media content. The questions may also be sponsored by sponsor partners. The “Create Question” dialog box enables an administrator to enter questions and answers, point values, and configure implementation options.

The administrative layer 207 makes multimedia content available for simulcasting by adding the multimedia content to the queue of current multimedia content. The administrative layer 207 may select a schedule or show time for viewing the multimedia content. The administrative layer 207 may further specify show times, or may rely on participants to create show times. The administrative layer 207 enables the administrators, the platform partners, and session moderators to authorize user-generated trivia questions during the discussion sessions.

The administrative layer 207 may identify and list active discussion sessions along with participant lists, participant history, and interactions history corresponding to each of the modalities. The administrative layer 207 may monitor and moderate the active discussion sessions. The administrative layer 207 may moderate a participant in a discussion session by sending a system message to the particular participant, to the participants in the discussion session, or to the participants in the discussion sessions. The system message may appear on top of the other application activities until the system message is dismissed by the participant. Alternatively or additionally, the participant may be restricted from taking part in in-session interactions with the other participants for a specified or open-ended amount of time. In order to restrict the participant, the participant may be removed from the discussion session and barred from re-entry. The active discussion session being monitored and moderated may be shut down, returning the participants in the discussion session to the lobby view. The participant's account may be locked for a specified or open-ended amount of time. The internet protocol (IP) address of the particular participant may be prevented from accessing the virtual interaction platform 201.

The administrative layer 207 may provide tools and interfaces for production of virtual discussion forums, including pre-production setup, live production during the discussion session, and post-production wrap up. For example, the media content may be loaded into the administrative layer 207 prior to or during a discussion session in the virtual discussion forum The media content may be transcoded into a displayable media format and made available to authorized producers. A production interface may be provided to enable the producers to order, queue, and simulcast the media content and related session content. Production details may be prespecified or manipulated in real-time during the discussion session. Further, a prompter interface may be provided to the session moderators or hosts to display selected media content and interactions from one or more virtual discussion forums. The prompter interface may provide context and information for session moderation and hosting. Production functionality may be separated from the administrative functionality and the computer implemented system disclosed herein may comprise a separate “production layer”. The production interface enables producers to run live online events requiring accuracy of control, for example, celebrity interviews, town hall meetings, etc. The producer can select live and recorded video input streams, preview the streams for playback, and then assign the streams to for simulcasting.

A client application resides on each of the client devices 210a, 210b, 210c, and 210d of the participants. The client application connects the client devices 210a, 210b, 210c, and 210d to a network 212 and enables the participants to join the virtual discussion forums. The streaming multimedia content of the discussion issues, queries and polls related to the discussion issues, participants' responses, in-platform advertisements, participant profiles, group dynamics etc. are graphically displayed on the GUI 203a provided by the client application, within a single window or in multiple windows. FIG. 2 illustrates multiple client devices 210a, 210b, 210c, and 210d accessing the virtual interaction platform 201 through the network 212. The media content, participant interactions, and other GUI elements are synchronized between client instances as applicable.

The GUI 203a may display simulcast media in an unconstrained aspect ratio eliminating dead space above and below the displayed media content. The participants post comments using the graduated interaction modes presented on the GUI 203a by the interaction layer 203. The commenting components are in the form of chat messages, bubble messages, etc. For example, the bubble messages may appear to be stacked on the GUI 203a of the interaction layer 203. Old bubble messages may fade out to keep current comments and make room for new bubble messages on the GUI 203a. The interaction layer 203 further comprises animated images and objects. For example, a participant may express laughter visually via an action of a user icon. Exemplarily, the participants may communicate with each other in the virtual discussion forum using linked chat messages. A linked chat begins when a participant links to a bubble comment before it fades, in order to post a linked reply in real-time. The bubble comments may be configured to offer a link enabling the participants to start a public conversation based on comments made by other participants in real-time. The linked chat turns a bubble comment into a public chat window. Multiple participants may participate in a linked chat, and multiple linked chats may take place simultaneously. Once established, the linked chats may be cancelled or exited by the participants. The linked chats fade out given a period of inactivity during the linked chats.

Rolling over a user icon on the GUI 203a may display basic profile information of a particular participant and related menu options. For example, the related menu options on the user icon may include options to add a co participant as a friend, block a co participant in the discussion session by hiding activities from the co participant, open a message window and invite the co participant to chat or message, play an audio clip, etc. Participants can chat with one another privately, via the instant messenger of the virtual interaction platform 201. For example, to initiate a chat with the co participant in a discussion session, a participant rolls over the user icon and clicks “Chat”. A chat or messenger service window is displayed to the participant. The participant who then initiates the chat types a message and clicks “Send”, which opens up a chat or messenger window on the GUI 203a of a recipient participant. The chat or messenger activity may also be initiated from the friends list in the participant profile. As an intimate form of user interaction, private chat is available for direct and private communication. The private chat component provides full-featured instant messaging built into a session interaction environment, with an acceptance or denial invitation mechanism, multiple independent chat windows, and emoticons. The private chat may be integrated with a user bar to enable participant invitation via the graphic user avatar rollover menu.

A participant may enter a discussion forum as a “guest”. Guests are able to view the simulcast multimedia and interactions between other in-session participants. When the guests attempt to use any of the interaction features such as comment, chat, polls, etc. the guests are prompted to login to the virtual interaction platform 201.

A participant may create an account to access the virtual interaction platform 201, either via a platform hosted account creation mechanism or from a partner website. The account information may include participant profile, e-mail address of the participant, etc. An automated participant's account manager may manage related account information comprising a list of friends, offline messages, settings, etc. The user accounts are stored in a platform database 211f or accessed using single sign-on (SSO) through credentials of the partner websites. The participant may log in to the virtual interaction platform 201 and the participant is validated using the SSO. A participant can access information about other co participants via a “miniprofile”. Miniprofile information is managed from the participant's account manager. Alternatively, the miniprofile can be replaced with a redirect to a partner social network service's (SNS) user profile.

The miniprofile is a participant profile accessible without leaving the session environment. The participant profile may be automatically augmented with a history of the participant's activity, for example, sessions attended by the participants, grabbed scenes, top comments, and trivia scores. The mini-profile can provide standalone light social-networking or present data from a customer's existing social network. A “personal ringtone” enables a participant to assign an audio clip as a way to express personal characteristics via music, voice, or other sound. Other participants may access the “personal ringtone” from the session user bar and the “miniprofile” by scanning through a user list and learning about each participant with minimal effort. As with the mini-profile, the “personal ringtone” provides a convenient way to sort through a group of strangers, as one might encounter in a public interactive session.

User controls provided on the GUI 203a comprise information and links related to login, including for example “username”, “link to sign out”, “link to profile”, etc. Related links and controls comprise an “invite link” to invite co participants to a discussion session, a “jump to” control that displays a drop down list of ongoing discussion sessions and enables a participant to exit current discussion session and enter a different discussion session. A “go to lobby” control enables a participant to exit the current discussion session and return to a lobby view.

Host controls are provided to designated participants or to a host participant creating the discussion session. The host participant, identified to the participants by a special user icon, is able to perform hosting tasks using host controls. The host participant is able to silence a participant in a discussion session for a specified or open-ended period of time. The host participant is also able to eject a participant permanently from the discussion session, barring the participant from re-entry. The host participant is also able to send a system message to a participant, either as part of one of the hosting tasks or separately, as a warning. While a discussion session is active, the host participant may also lock and unlock the discussion session, preventing or allowing entry of the participants involved. The host participant may also add or remove participant names from list of the participants involved. The host participant may also shut down the discussion session, returning the participants involved to the lobby view.

FIG. 3A exemplarily illustrates a lobby view of virtual discussion forums. When new participants access the virtual interaction platform 201, the new participants are presented with the lobby view of the virtual discussion forums active at an instant when the new participants access the virtual interaction platform 201. For example, the virtual discussion forums may be hosting discussions on political topics, environmental issues, social issues, etc. The lobby view also displays a discussion schedule, as well as current activities of the virtual discussion forums. For example, latest comments and opinions from existing participants already involved in each of the virtual discussion forums may be displayed. Real time user activity for current discussion sessions in progress may be displayed. Alternatively, activity list may be filtered by topic, friends list, etc.

Further, along with the participants' comments, option to join respective virtual discussion forums may be provided by a jump-in link. The activity based initiation of a participant entering into a discussion forum, based on viewing the real-time user activity existing in the virtual discussion forum, brings together people with common interests, concerns, tastes, sense of humor, etc., into related virtual discussion forums in real time.

The lobby view also enables participants to create personal virtual discussion forums, schedule the personal virtual discussion forums, and make the personal virtual discussion forums publicly available or accessible only to participants' friends or a particular invitation list. The participant may also send invitations to a list of friends or send announcements to friends containing information about the discussion session. The participant's account manager may display a list of upcoming discussion sessions created by the participant or invited into.

FIG. 3B exemplarily illustrates real-time synchronous group interaction among multiple participants in an online debate in a virtual discussion forum. Exemplarily, the online debate is an environmental debate on usage of ethanol and biodiesel as fuel. The synchronous media layer 202 broadcasts live media content presenting viewpoints of debators, “Bob” and “Alice”. Further, comments and viewpoints of a discussion moderator of the debate are also displayed. The participants involved in the debate may be able to view the live debate between Bob and Alice on respective client devices 210a, 210b, 210c, and 210d of the participants. The polling engine 209 presents polling questions to the participants related to biodiesel and ethanol. Also, the polling engine 209 enables the participants to submit potential debate questions and vote as a group as to determine the questions to be addressed by the debaters, order of the questions, etc. The participants may cast votes in real-time by clicking graphical buttons provided by the interaction layer 203. The RAA layer 206 determines the group behavior of the participants and provides the polling statistics to be displayed. Further, the crowd visualization displays the participants' alignment with respect to the usage of ethanol or biodiesel as fuel. The marketing layer 204 selects an automotive advertisement related to current topic of discussion. The automotive advertisement is presented on the GUI 203a by the interaction layer 203. The opinions and the comments from the participants are also displayed as linked chat messages. Recent comments made by a participant are clearly visible while older comments made by the participants gradually fade and eventually disappear.

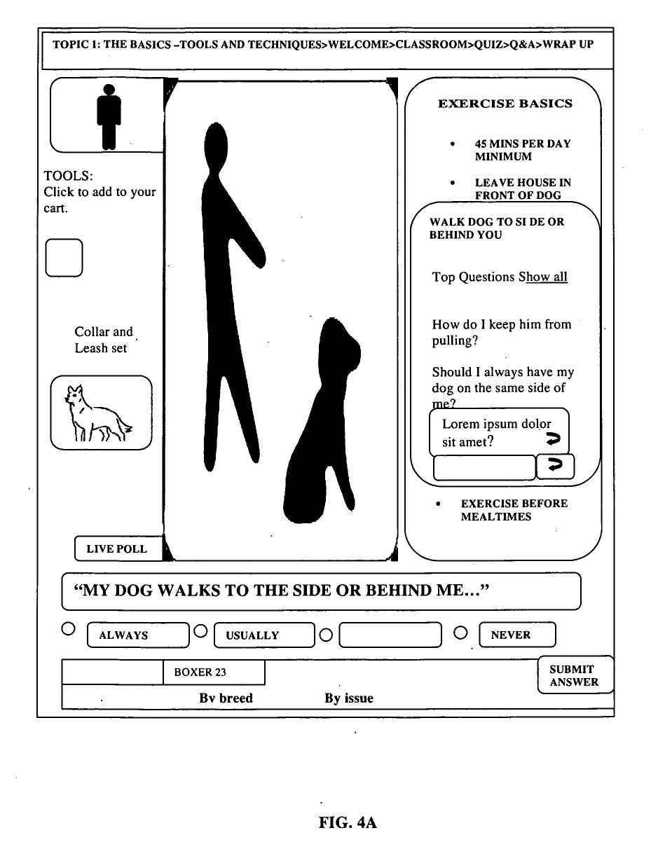

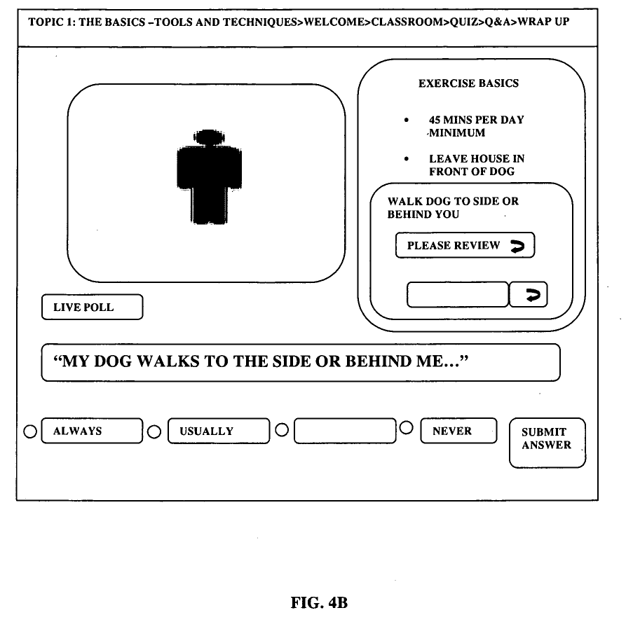

FIGS. 4A-4B exemplarily illustrate a web seminar conducted in the virtual discussion forum. Exemplarily, the web seminar is conducted to teach the participants about walking exercises for pet dogs. A streaming video of “Jane”, seminar moderator of the web seminar, is displayed on the virtual discussion forum. The video of “Jane” is a live video content streaming from a webcam of “Jane”. Additionally, a recorded video showing the walking exercises for the pet dogs is displayed on the GUI 203a. FIG. 4A illustrates combined streaming of recorded and live media content in the web seminar. “Jane” speaks in tandem with a recorded video content. The polling engine 209 of the virtual interaction platform 201 enables “Jane” to post questions to the participants involved in the web seminar and conduct polls related to the pet dogs. The participants respond to the posted questions using the reply window provided on the GUI 203a. The participants may post queries to “Jane” and other co participants using the comment component of the GUI 203a. The RAA layer 206 analyzes the responses from the participants to the polls and questions posted by “Jane”. The RAA layer 206 provides statistical data on performance of the participants as a group in the web seminar to “Jane”. “Jane” uses the statistical data to prudently conduct the web seminar to enable the participants to derive maximum learning experience from the web seminar, via the prompter interface of the administrative layer 207. The marketing layer 204 displays a list of merchandises for the pet dogs such as collars, leashes, etc. The participants may select an item from the listed merchandises and buy online while the web seminar is in progress.

The polling engine 209 enables the administrators, platform partners, and the participants to author questions. An authoring interface provides a series of question templates such as multiple choice, multiple selection, ranking, and essay type questions. A question may be selected by a platform partner to appear during a discussion by first adding the question to a “pool”. The pool is then assigned to a discussion or assigned to every discussion. Individual questions may be added to multiple pools. Individual pools may be assigned to multiple discussions.

Once a pool has been assigned to a discussion, multiple properties may be set. The properties comprise order of displaying the questions, schedule of displaying the questions during a discussion session, display of sponsor messages or advertisement images, etc. Scores may be awarded to the participants for answering the questions. The scoring may be based on the timing of the answer submitted by a participant. The awarded scores may be tracked by the participant during the discussion session. The GUI 203a may display a leader board component during the discussion session.

The administrators, the platform partners, and the participants may conduct polls individually by authoring specific questions. The polling engine 209 provides the participants with flexible question formats. The poll questions are time coded relative to the multimedia content. Polling logic is branched to select new questions based on the responses from the participants to previous questions. The virtual interaction platform 201 may allow sponsored questions to be presented in the discussion sessions. Results of the polls may be analyzed by the RAA layer 206 and may contribute to determining the group behavior and the group dynamics. The polling engine 209 graphically displays the results of polling via crowd visualization.

FIGS. 5A-5C exemplarily illustrate crowd visualization in the virtual discussion forum. FIG. 5A exemplarily illustrates attraction traits of individual participants in the virtual discussion forum. Attraction between the participants is exemplarily represented as clustering of circular images of each of the participants. Size of a cluster may visually denote number of the participants attracted to a particular participant. FIG. 5B exemplarily illustrates the popularity attribute of individual participants. Area of a circular image of a participant implies popularity level of the participant. Larger circles represent participants with levels of popularity greater than other participants. FIG. 5C exemplarily illustrates the visualization of the polarity of the participants. The polarity implies categorization of opinions or perspectives of the participants on questions presented in the virtual discussion forum.

FIG. 5D exemplarily illustrates the display of responses posted by the participants in a linked chat window of the virtual discussion forum. Exemplarily, the participants communicate with each other in the virtual discussion forum using linked chat messages. A linked chat begins when a participant links to a bubble comment before it fades, in order to post a linked reply in real-time.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

Where databases are described such as the platform database 211f, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The foregoing examples have been provided merely for the purpose of explanation and are in no way to be construed as limiting of the present invention. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of enabling real-time synchronous group interactions among a plurality of participants in a virtual discussion forum, comprising the steps of:
providing a virtual interaction platform to said participants for said synchronous group interactions, wherein said virtual interaction platform comprises a synchronous media layer, an interaction layer, and a reporting, archiving, and analysis layer;
enabling the synchronous group interactions among the participants in said virtual discussion forum using the virtual interaction platform, comprising the steps of:
introducing a plurality of discussion issues for the virtual discussion forum;
synchronously rendering media content related to said discussion issues to the participants using said synchronous media layer, wherein said media content is obtained from a plurality of media sources;
generating responses by the participants on the discussion issues using said interaction layer;
analyzing group behavior of the participants by said reporting, archiving, and analysis layer using said generated responses; and
dynamically displaying said group behavior by the interaction layer.
whereby the virtual interaction platform enables said real-time synchronous group interactions among the participants in the virtual discussion forum.

2. The computer implemented method of claim 1, wherein the virtual interaction platform further comprises a marketing layer, wherein said marketing layer enables targeting of advertisements, product placements, sponsorships, and merchandising to the participants in the virtual discussion forum.

3. The computer implemented method of claim 1, wherein said step of enabling the synchronous group interactions among the participants further comprises a step of enabling the participants to join the synchronous group interactions on the discussion issues based on real time user activity in the virtual discussion forum.

4. The computer implemented method of claim 1, wherein the virtual interaction platform further comprises a social networking layer for facilitating asynchronous group interactions among the participants.

5. The computer implemented method of claim 1, wherein the virtual discussion forum is one of a web seminar, an online conference session, an online debate, an online learning session, and an online social gathering.

6. The computer implemented method of claim 1, wherein the participants use one or more of chat messages, bubble messages, comment components, user icons, and graphical user interface widgets during the synchronous group interactions.

7. The computer implemented method of claim 1, wherein said synchronously rendered media content is live media content, recorded media content, and any combination thereof.

8. The computer implemented method of claim 1, further comprising the step of polling the participants with questions based on the discussion issues.

9. The computer implemented method of claim 1, wherein the virtual interaction platform further comprises an administrative layer, wherein said administrative layer provides tools and application programming interfaces for managing virtual discussions, customizing the virtual interaction platform, branding, marketing and merchandising, authenticating the participants, and managing administrative functionalities.

10. The computer implemented method of claim 9, wherein the administrative layer manages administrative accounts of platform partners of the virtual interaction platform, wherein said platform partners comprise partner websites and sponsoring partners of the virtual interaction platform.

11. The computer implemented method of claim 1, wherein the virtual interaction platform further comprises an operations layer for supporting a turnkey hosted solution provided by platform partners on the virtual interaction platform.

12. A computer implemented system for enabling real-time synchronous group interactions among a plurality of participants in a virtual discussion forum, comprising:
a virtual interaction platform for enabling said real-time synchronous group interactions among said participants in said virtual discussion forum, comprising:
a synchronous media layer for rendering media content related to a plurality of discussion issues to the participants, wherein said media content is obtained from a plurality of media sources;
an interaction layer for enabling the participants to generate interactions and responses on said discussion issues; and
a reporting, archiving, and analysis layer for analyzing group behavior of the participants using said generated responses.

13. The computer implemented system of claim 12, wherein said virtual interaction platform utilizes a platform server for enabling the real-time synchronous group interactions, wherein said platform server comprises a stream module, a web service module, an interaction module, and a platform database.

14. The computer implemented system of claim 13, wherein said stream module publishes the media content to the participants.

15. The computer implemented system of claim 13, wherein said web service module comprises a web streamer for streaming non interactive media content on demand of the participants, further wherein the web service module further comprises a web grabber for capturing user-selected scenes grabbed from real-time streaming video content.

16. The computer implemented system of claim 13, wherein said interaction module controls changeovers during entry and exit of the participants from a discussion session on the virtual interaction platform.

17. The computer implemented system of claim 13, wherein said platform database stores and retrieves user account information, session schedule and session information, trivia questions, partner and client configurations, and logs diagnostics and session activity via said interaction module.

18. The computer implemented system of claim 12, wherein said virtual interaction platform further comprises a polling engine for polling the participants with questions based on the discussion issues.

19. The computer implemented system of claim 12, wherein said virtual interaction platform further comprises a social networking layer for facilitating asynchronous group interactions among the participants.

20. The computer implemented system of claim 12, wherein said virtual interaction platform further comprises a marketing layer for enables targeting of advertisements, product placements, sponsorships, and merchandising to the participants in the virtual discussion forum.

21. The computer implemented system of claim 12, wherein said virtual interaction platform further comprises an administrative layer for providing tools and application programming interfaces for managing setup and production of virtual discussions, customizing the virtual interaction platform, branding, marketing and merchandising, authenticating the participants, and managing layers of the virtual interaction platform.

22. The computer implemented system of claim 12, wherein said virtual interaction platform further comprises an operations layer on the virtual interaction platform for supporting a turnkey hosted solution provided by platform partners on the virtual interaction platform.

23. The computer implemented system of claim 12, wherein said virtual interaction platform utilizes an inner login for supporting user login and providing application wrappers.

24. The computer implemented system of claim 12, wherein said interaction layer comprises a graphical user interface for graphically displaying the group behavior.

25. A computer program product comprising computer executable instructions embodied in a computer-readable medium, wherein said computer program product comprises:
a first computer parsable program code for providing a virtual interaction platform to a plurality of participants for synchronous group interactions, wherein said virtual interaction platform comprises a synchronous media layer, an interaction layer, and a reporting, archiving, and analysis layer;
a second computer parsable program code for introducing a plurality of discussion issues for a virtual discussion forum;
a third computer parsable program code for synchronously rendering media content related to said discussion issues to said participants using said synchronous media layer;
a fourth computer parsable program code for generating responses by the participants on the discussion issues using said interaction layer;
a fifth computer parsable program code for analyzing group behavior of the participants by said reporting, archiving, and analysis layer using said generated responses; and
a sixth computer parsable program code for dynamically displaying said group behavior by the interaction layer.
